(19) United States
(12) Patent Application Publication
(10) Pub. No.: US 2010/0022221 A1
(43) Pub. Date: Jan. 28, 2010

(54) REAL-TIME INVENTORY TRACKING VIA MOBILE DEVICE

(75) Inventors: Jeonghee Yi, San Jose, CA (US); Marc Davis, San Francisco, CA (US); Farzin Maghoul, Hayward, CA (US); Paul Yiu, Santa Clara, CA (US)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 12/180,052

(22) Filed: Jul. 25, 2008

(51) Int. Cl. H04M 3/42; G06Q 10/00; G01C 21/00

(52) U.S. Cl. 455/414.1; 705/5; 705/28; 701/213

(57) ABSTRACT

A computer-implemented method is disclosed for real-time inventory tracking with a mobile device, including: receiving a communication for a stationary inventory item via a cellular or wireless network from a tracking server that is coupled with the cellular or wireless network; and tracking the stationary inventory item on a registered consumer mobile device in real-time via the cellular or wireless network, wherein tracking comprises: receiving an updated status regarding a quantity and a location related to the stationary inventory item; and displaying the updated status on a screen of the mobile device in real time.

### BACKGROUND

1. Technical Field

The disclosed embodiments relate to systems and methods for real-time inventory tracking, and more specifically, for tracking, in real time, inventoried items by a consumer with a mobile device.

2. Related Art

Consumers and business people increasingly use mobile phones or similar devices with which to communicate and to obtain information. These same people also look up information on the World Wide Web (“Web”) or Internet (via mobile device or personal computer) to find out information regarding goods and services in commerce. For instance, a consumer may seek for availability of seats in a theater for a play or movie or for openings at a beauty salon or barber's shop. Consumers regularly also consume goods online, but often simply try to perform research over the Internet to learn more about an item of interest before purchasing. The consumers then go to the store to ask more questions and/or to purchase the goods, sometimes running in difficulties with finding what they need within the brick-and-mortar store. What they want, however, is the item the consumer found online to also be available at that store when they go to the brick-and-mortar store to purchase that item.

For instance, a consumer or contractor may need a variety of electrical cables and connections with which to finish a basement of a house. The consumer or contractor first looks on the website of The Home Depot™ to research the correct gauge, power levels, and connections. Upon entering the store, however, finding the proper items within The Home Depot™ store may pose more of a challenge than expected, ultimately requiring the help of an associate to find all that is required to finish the basement. It could be, in fact, that The Home Depot™ (or other brick-and-mortar store) has run out of that item.

In another example, the object is broadened to include availability at a restaurant or a space at a parking garage or an open chair in a barber's shop. Before driving from one part of town to another to eat at a restaurant, one may wish to quickly learn the availability of one or both of parking nearby and at tables at the restaurant.

### SUMMARY

By way of introduction, the embodiments described below are drawn to systems and methods for real-time inventory tracking, and more specifically, for tracking, in real time, inventoried items by a consumer with a mobile device.

In a first aspect, a computer-implemented method is disclosed for real-time inventory tracking with a mobile device, including: receiving a communication for a stationary inventory item via a cellular or wireless network from a tracking server that is coupled with the cellular or wireless network; and tracking the stationary inventory item on a registered consumer mobile device in real-time via the cellular or wireless network, wherein tracking comprises: receiving an updated status regarding a quantity and a location related to the stationary inventory item; and displaying the updated status on a screen of the mobile device in real time.

In a second aspect, a computer-implemented method is disclosed for facilitating real-time mobile device tracking of inventory items, including: registering an inventory item for a merchant with a server over a network; receiving regular status updates by the server comprising at least a quantity and location of the inventory item, wherein the regular status updates are indexed in a database of the server; and sending regular status updates, by the server, to previously-registered consumer mobile devices through a cellular or wireless network, wherein the status updates are displayed on a screen of the mobile devices, which enables the consumers to track at least the location and quantity of the inventory item.

In a third aspect, a system is disclosed for enabling real-time inventory tracking with mobile devices. The system includes a server to enable merchants to register an inventory item over a network for the purpose of tracking the inventory item in real time. The server is configured to receive regular updates comprising at least a quantity and a location of the inventory item from the merchants. A database is coupled with the server to index and store the updates of the inventory item. A processor is coupled with the server and configured to: process the regular updates so that the at least quantity and location is current for the inventory item; and send regular updates to mobile devices of consumers through a cellular or wireless network, wherein the updates are displayed on a screen of the mobile devices, which enables the consumers to track at least the location and quantity of the inventory item.

In a fourth aspect, a consumer mobile device is disclosed for real-time inventory tracking, including a transmitter configured to communicate over a cellular or wireless network with a tracking server containing updated information related to an inventory item, wherein the tracking server is coupled with the network. A processor is coupled with the transmitter configured to register the mobile device with the tracking server to continuously track the inventory item. A receiver is coupled with the processor and configured to receive a communication for the inventory item via the cellular or wireless network from the tracking server, wherein the communication for the inventory item includes real-time updates of at least a location and a quantity of the inventory item. A display is coupled with the processor and configured to display the real-time updates of the inventory item as received from the tracking server, wherein the updated includes at least a location and quantity of the inventory item.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The system may be better understood with reference to the following drawings and description. The components in the figures are not necessarily to scale, emphasis instead being placed upon illustrating the principles of the invention. Moreover, in the figures, like-referenced numerals designate corresponding parts throughout the different views.

FIG. 1 is a diagram of an exemplary system for tracking in real time inventoried items by a consumer with a mobile device.

FIG. 2 is another embodiment of the system of FIG. 1, showing additional detail in the tracking server, which may integrate therewith or be in communication with search capability.

FIG. 3 is an exemplary mobile device capable of interfacing with the tracking system as disclosed with reference to FIGS. 1 and 2.

FIG. 4 is a flow chart of an exemplary method for tracking in real time inventoried items by a consumer with a mobile device.

FIG. 5 is a flow chart of another embodiment of a method for tracking in real time inventoried items by a consumer with a mobile device.

### DETAILED DESCRIPTION

By way of introduction, to systems and methods for real-time inventory tracking, and more specifically, for tracking, in real time, inventoried items by a consumer with a mobile device. Development of a system and corresponding methods by which consumers are able to track, in real time, inventoried items satisfies consumers' desires to both obtain what they want, when they want it, but also save time in the process. Time is saved by not making an unnecessary trip when an inventoried item is not available or has been discontinued.

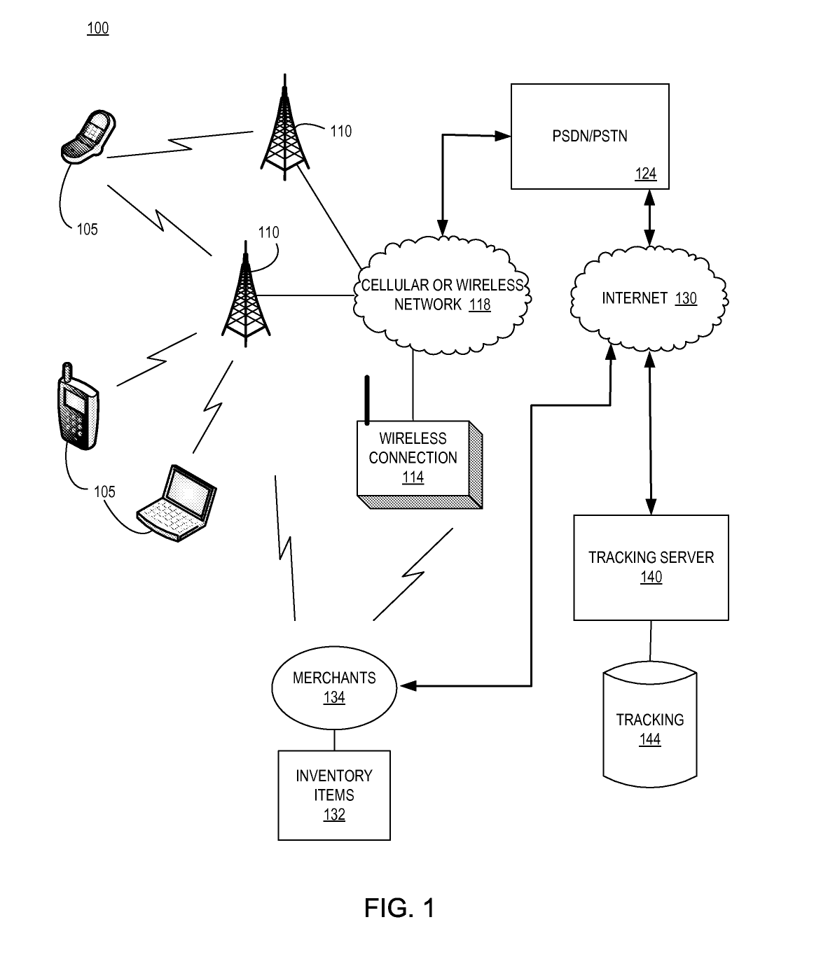

FIG. 1 is a diagram of an exemplary system 100 for tracking in real time inventoried items by a consumer with a mobile device 105. Mobile devices 105 over which the embodiments disclosed herein may be implemented include, but are not limited to, cell phones, personal digital assistants (PDAs), a Blackberry™ by Research in Motion™, a laptop computer, a Bluetooth device, and any other mobile or semi-mobile device 105. The mobile devices 105 may wirelessly communicate with base transceiver stations 110, also referred to as cell cites or cellular towers. The system 100 may further include a wireless connection 114, such as a wireless hub, router, or the like, and a cellular and/or wireless network 118. The wireless network 118 may involve WiFi, Bluetooth, 802.11a, 802.11b, or the like technology for passing networked data. The system 100 may further include a Public Switched Data (and/or Telephone) Network (PSDN/PSTN) 124, an Internet 130, a plurality of traceable inventory items 132 from merchants 134, a tracking server 140, and a tracking database 144.

The base transceiver stations 110 communicate through the cellular or wireless network 118, which may include various pieces of switching hardware such as routers, switches, hubs, etc. The cellular network 118 may include the wireless connection 114 through which the mobile devices 105 may optionally obtain network communication for voice and data. The inventory items 132 may also gain network access through the wireless connection 114 and/or the base transceiver stations 110. Any local wireless connections 114 as well as the base transceiver stations 110 are coupled with the wireless network 118, which in turn is coupled with the PDSN/PTSN 124. Herein, the phrase “coupled with” is defined to mean directly connected to or indirectly connected through one or more intermediate components. The PSDN/PSTN 124 may be coupled with an Internet 130 or other network for communication with the tracking server 140 and the tracking database 144. The Internet 130, therefore, may encompass other networks such as an intranet, a local area network (LAN), a wide area network (WAN), etc. The PSDN/PSTN 124 may include or be coupled with an Internet gateway (not shown) to facilitate access to the Internet 130. The mobile devices 105 may transfer and receive digital information or electronic data through the cellular or wireless network 118 and over the Internet 130.

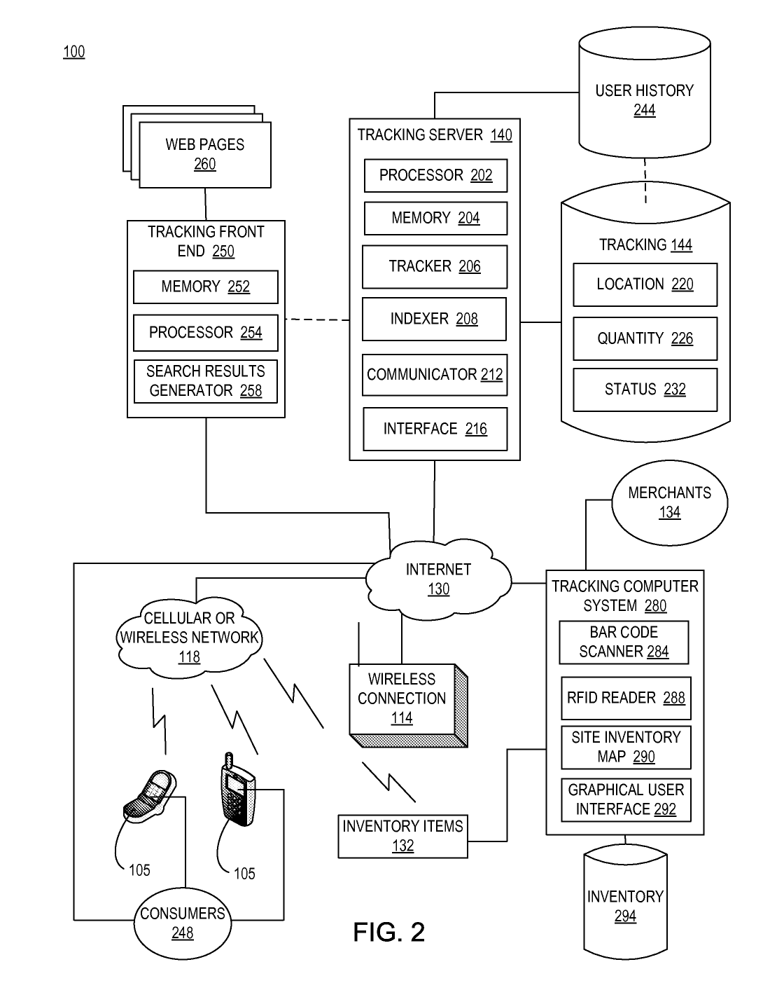

FIG. 2 is another embodiment of the system 100 of FIG. 1, showing additional detail in the tracking server 140, which may integrate therewith or be in communication with search capability. Reference will be made to some of the same features as discussed above, and detailed explanation thereof is omitted. The tracking server 140 may include a processor 202, a memory 204, a tracker 206, an indexer 208, a communicator 212, and a user interface 216. The tracking server 140 includes the tracking database 144, which may store and index a location 220, a quantity 226, and a status 232 for the inventory items 132, thus acting as a type of registry for inventory items 132 of various merchants 134. The tracking server 140 may also include a user history database 244, which may include purchase, browsing, and/or search-related historical information indexed by the indexer 208 such as to form a personalized search index specific to a plurality of individual users or consumers 248. The system 100 may further include a tracking front end 250 that is integrated or otherwise coupled with the tracking server 140, although the coupling may take place through the Internet 130 or other network. The tracking front end 250 may include a memory 252, a processor 254, a search results generator 258, as well as computer-generated web pages 260.

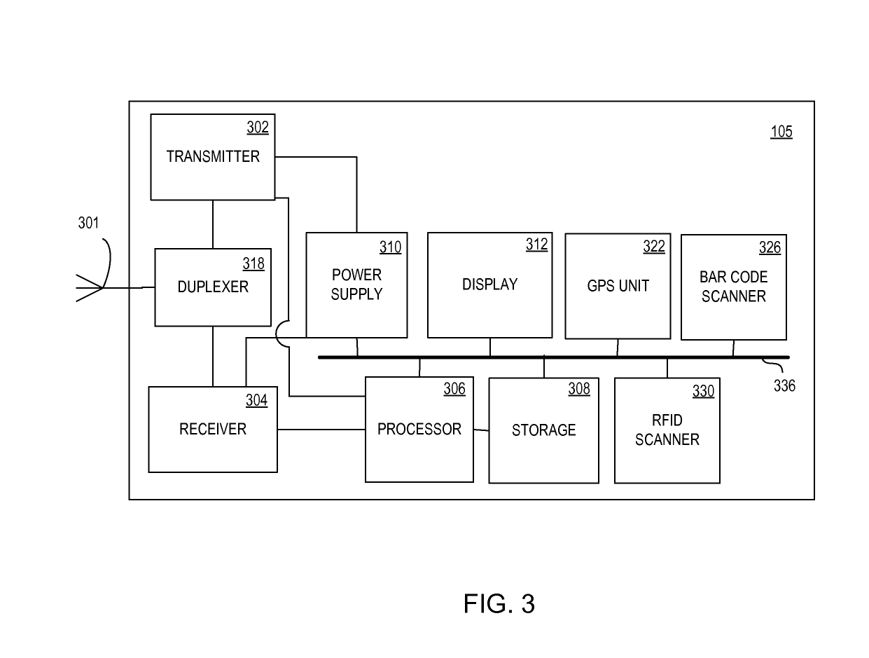

The merchants 134 may own or lease a tracking computer system 280 to enhance their ability to track their inventory items 132. The tracking computer system 280 may include a barcode scanner (or reader) 284, a radio frequency identification (RFID) scanner (or reader) 288, other types of scanners (not shown), a site inventory map 290, and a graphical user interface (GUI) 292 for interaction with the tracking computer system 280, to include manual input by the merchants 134 of the inventory-related information directly therein. Other additional features may be included as would be apparent to one of ordinary skill in the art, such as a memory (not shown) and a microprocessor (not shown). The tracking computer system 280 may also include an inventory database 294 for storing tracking-related information before being communicated to the tracking server 140. At least some of these capabilities may be made compatible with smart mobile devices 105 as will be discussed in more detail with reference to FIG. 3. The plurality of consumers 248 may access, or receive updates regarding, product or service-related inventory information stored in the tracking database 144 and/or the inventory database 294.

In one embodiment, the tracker 206 of the tracking server 140 communicates through the communicator 212 directly with the inventory items 132 of one or more merchants 134 through the Internet 130. The inventory items 132 of the merchants 134 may communicate directly with the tracking server 140 through the cellular or wireless network 118, to which they gain access through the transceiver base stations 110 and/or local wireless connections 114. Digital data packets containing inventory-related information such as location, quantity, and status are communicated through the PSDN 124 and through the Internet 130 to be stored by the tracking server 140 in its tracking database 144.

The tracking front end 250 may provide search capability to the inventory items 132 over the Internet 130 to consumers. Through Web search, consumers enter in keywords or phrases into a search tool (not shown) of a Web page corresponding to the tracking front end 250. In response, the tracking front end 250 executes at least a relevancy-based search with its search results generator 258, which may be executed with the aid of a search engine (not shown). The search results generator 258 returns a list of computer-generated web pages 260 to the browser of the consumers. The search results may then correspond to the terms searched for, which may include products and services provided by the merchants 134. The search results, therefore, may include information and/or marketing copy related to the products and services of interest to the consumers. This information may relate to a brick-and-mortar store to which the consumer may have more interest in visiting than in actually making an online purchase.

Because the tracking front end 250 is coupled with (or integrated within) the tracking server 140, the tracking server 140 may provide real-time inventory-related information as it is received from the merchants 134 over the Internet 130 as a part of the search results, or as an auxiliary service to consumers 248 that register to receive such information. The inventory-related information may then be provided to the consumers 248 in their browsers on their personal computers (not shown) as well as to the consumers 248 over their mobile devices 105, advantageously allowing the consumers 248 to receive up-to-date inventory information that may affect their travel plans in regards to visiting the brick-and-mortar store at any given moment. One aspect of the delivery mechanism of the inventory-related data to the consumers 248 may include a personalized search index such as the user history database 244, which may be built by the indexer 208. From the user history database 244, the consumers 248 may search for or receive updates related to specific items of interest for which they have registered. The user history database 244 includes an index that is kept current based on current inventory quantities, locations, and statuses, and that may also contain historical inventory data, which may include purchasing history of a specific user 248 tracked according to registration of mobile devices 105.

The consumers 248 are generally most interested in receiving status updates for stationary inventory items 132, e.g., what would be available today if the consumer traveled to the brick-and-mortar store to purchase the good or service related to the inventory item 132. This interest contrasts that of the merchants 134 who likely, as part of their tracking computer system 280, also track their inventory items 132 while in transit, e.g., where is an inventory item 132 located and when is it due to arrive, etc.

The consumers (or users) 248 may be required to register themselves and/or their mobile devices 105 for such inventory-related update services through one of the tracking server 140 or through the tracking computer system 280. Registration of consumers 248 enables the consumers to choose the type of information they would like, such as based on a state change or based on specific attributes of the inventory items 132, examples of which will be discussed below. In receiving the information, the consumers 248 can search or browse to updates over their mobile devices 105, or receive automatic updates through an email or text message, or the like. Such updates may be made in a continuous manner to the mobile devices 105.

For instance, after entering a parking lot, the mobile device 105 of a consumer 248 registers its access information and an interest for a parking spot with the inventory registration system of the parking structure (not shown). The occupancy attribute of the mobile phone 105 as correlated with this parking structure is set to empty. The inventory system 100, such as either the tracking server 140 or the tracking computer system 280, transmits the location of a parking spot to the mobile device 105 with the required locater information. If the user 248 accepts that transmitted location, the occupancy attribute is set to occupied and the user 248 has access to the particular parking spot until the user 248 leaves the same, creating an open spot once again.

If a merchant 134 lacks smart inventory items, for instance each parking spot may not electronically sense cars that come and go for specific parking spots, than a certain level of manual or other form of electronic tracking may be sufficient. For instance, with the example of the parking garage, a number of vehicles that come and go from the garage may be tracked at the garage access where car drivers retrieve a ticket and later pay for that ticket as they leave. Total inventory availability may still be performed, e.g., how many parking spots are free for parking, albeit without specific parking spot availabilities.

The tracking of the inventory items 132 generally, therefore, takes place in an automated fashion, but may also be facilitated by a merchant 134 entering the real-time inventory data directly into the tracking computer system 280 by way of the GUI 292. The tracking computer system 280 may then transmit, in real-time, the inventory data to the mobile devices 105 of the users or to the central tracking server 140 to be combined with related data as an inventory update. Note that automated or manual-type tracking of availabilities may be applied to many types of availabilities that may variably referred to herein a “service slot.” Other examples include open chairs at a salon or barber's shop, open seats in a theater, or availability in a hotel or at a restaurant, etc. Products, of course, may also be tracked.

In another embodiment, the tracking computer system 280 may be automated by use of barcodes, RFID tags, and/or other types of traceable devices (such as smart transceivers) that may be tracked with use of the barcode and RFID readers 284, 288, or other type of smart transceiver reader. When such readers are brought within sufficient proximity of barcodes, RFID tags, or other smart transceivers, the barcode or RFID readers 284, 288 may detect the identity of the underlying product or availability, including a status thereof. Having an automated tracking system 280 facilitates tracking of potentially large volumes of information regarding relevant inventory items 132. Not all items (or availabilities) 132 for sale by the merchants 134 may be inventoried for tracking, but those that are, may be inventoried and tracked through the tracking computer system 280. The computer and networked systems disclosed herein may include one or more subparts of existing inventory systems used for commercial tracking of inventories for the purposes of re-ordering or just-in-time replacement schemes.

The inventory-related information used to track the inventory items 132 may be stored locally in the inventory database 294 of the tracking computer system 280. The inventory-related information may then be sent to the tracker server 140 for storage in the tracking database 144 thereof. Updates of the tracking database 144 by the tracking computer system 280 may be performed intermittently, but preferably often so that information received by consumers from the tracking server 140 is as updated as often as possible. In this embodiment, the tracking computer system 280 may also directly provide to the consumers real-time inventory-related information, by-passing the central tracking server 140. For large companies or for companies with many locations, having localized sources of inventory information may not serve the consumers as well as providing a centralized tracking server 140 that could provide inventory-related information for all stores in the vicinity of a consumer 248.

The information obtainable from the merchants 134 may include a location of each inventory item 132, a quantity, and/or a status of each item 132. The location of each inventory item 132 may include a global positioning system (GPS) position, an aisle and section number, a restaurant table, a barber chair, an area of a store, etc. The site inventory map 290 may function to provide actual locations as seen on a map within a brink-and-mortar store (e.g., of an item on the shelf), office building (e.g., of a conference room), a parking lot (e.g., of a parking space), etc., in order to provide precise locations of such availabilities and visual indicators of how to find the same. The status of each item may include such information as, but not limited to: (1) in transit; (2) in storage; (3) on the shelves; (4) is or is not available; (5) is or is not in stock; (6) out of stock, but will arrive by a certain (future) date; (7) location of current availability (perhaps with an actual site map), etc. This type of information, or more or different information, may be communicated by the merchants 134 to the tracking server 140 in real time to enable a central repository of such information in the tracking database 144. This information may also be stored locally in the inventory database 294 of the tracking computer system 280, which may provide locally-relevant inventory information.

The system 100 herein disclosed also enables consumers 248 to register for inventory-related updates and information over their mobile devices 105 that may be broadly drawn to availability of items of interest, such as restaurants or movies (whether to attend or rent certain types of movies), the location of the movies or restaurants, and the intent of the consumer, e.g., what kind of content or type of movies the consumer enjoys, or what kind of food the consumers wants to eat. Receiving real-time, updated information of an inventory nature for such information provides personalized service to specific users/consumers 248 that have specific tastes and preferences. Furthermore, any store owner or service provider (merchants 134) can be seen as a provider of information that benefits from the system 100 by broadcasting specific information to registered users 248 according to their individual interests. This provides not only practical, inventory-related information, but also an on-going source of advertising.

FIG. 3 is an exemplary mobile device 105 capable of interfacing with the tracking system 100 as disclosed with reference to FIGS. 1 and 2. The mobile device 105 includes an antenna 301, a transmitter 302, a receiver 304, a processor 306, a storage 308, a power supply 310, a display 312, a duplexer 318, a global positioning system (GPS) unit 322. The mobile device 105 also optionally may include a barcode scanner 326 and/or a radio frequency identification (RFID) scanner 330. The storage 308 may include software to control the barcode scanner 326 or the RFID scanner 330, as appropriate.

As shown in this embodiment, the processor 306, the storage 308, the power supply 310, the display 312, the GPS unit 322, the barcode scanner 326, and RFID scanner 330 are coupled to a communications bus 336. The communications bus 330 is operable to transmit control and communications signals from and between the components connected to the bus 336, such as power regulation, memory access instructions, GPS location, barcode read product information, RFID tag sensed information, and other system information. In this embodiment, the processor 306 is coupled to the receiver 304 and to the transmitter 302. One of skill in the art will appreciate that the processor 306 may include the GPS unit 322. Also, the antenna 301 could be configured to connect through the local wireless connection 120, to include a Wi-Fi connection, etc. The GPS unit 322 enables the tracking server 140 to obtain location information of registered consumers 248 to then match up registered-for inventory-related information with correct locations, e.g., of specific theaters, movies, restaurants, or stores.

With a mobile device 105 such as that disclosed in FIG. 3, a consumer is enabled to directly check certain types of inventory items 132 to verify they are the items the consumer 248 seeks. For instance, whether a product is the product the consumer 248 found online could be instantly ascertainable by using the mobile device 105 as a barcode or RFID scanner on a product sitting on the shelves of a brink-and-mortar store. Such use of the mobile device 105 will cause the mobile device 105 to access the tracking database 144 or inventory database 294, and look up the identification of the inventory item 132 therein. Displayed on the display 312 of the mobile device 105 to aid the consumer 248 in identification of the inventory item 132 may include a picture, a product number, and/or other identifying names, model and display numbers, etc. Such use of the mobile device 105 enhances the mobile device 105 as a tool that helps consumers 248 both confirm inventory availability in advance, and verify the inventory item 132 once the consumer 248 locates what he or she thinks is the inventory item 132 found in advance over the Internet 130 or other network.

Furthermore, many mobile devices 105 today include calendars or task lists (neither shown) that aid users 248 of the mobile devices 105 to stay organized. The mobile device 105 may optionally be set up to automatically update the calendar and/or task list based on receipt of an update of an inventory-related data on one of the inventory items 132. For example, the mobile device 105 may be configured to create a calendar date and time every Friday night to eat at a preferred restaurant if the mobile device 105 receives an update by a certain day/time during the week that the preferred restaurant has table availability for Friday night. This feature may be especially useful where the venue is one that is difficult to reserve because it is so popular. The mobile device 105 may be required to successfully reserve a table at the restaurant on behalf of the mobile device user 248 before creating the calendar entry.

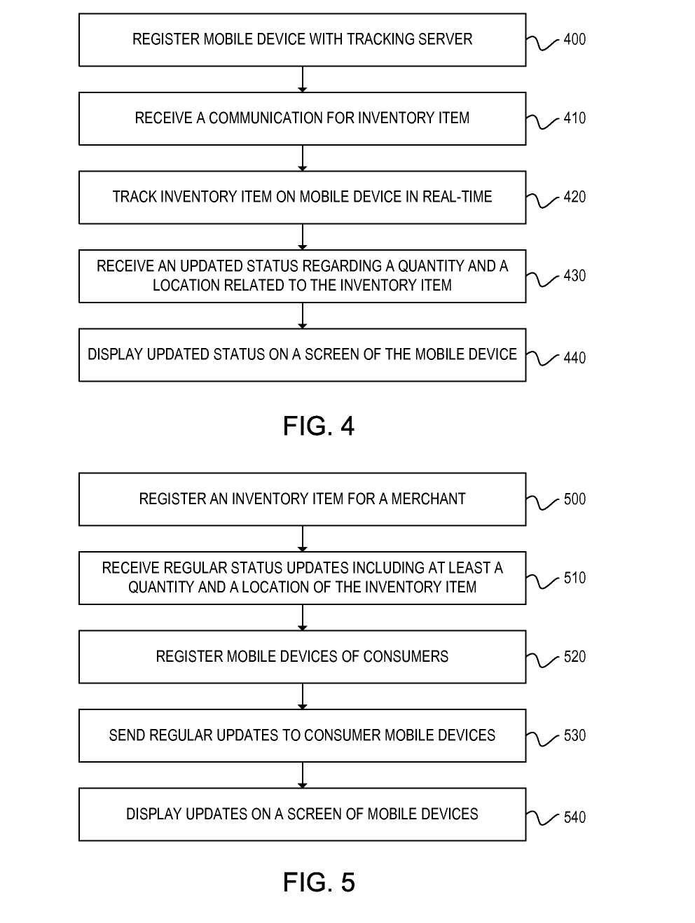

FIG. 4 is a flow chart of an exemplary method for tracking in real time inventoried items by a consumer with a mobile device. At block 400, a mobile device 105 is registered with a tracking server 140 to track an inventory item 132 through a cellular or wireless network 118, wherein the tracking server 140 is coupled with the network 118. At block 410, the mobile device 105 receives a communication for the inventory item 132 via the cellular or wireless network 118 from the tracking server 140. At block 420, the inventory item 132 is tracked on the mobile device 105 in real-time via the cellular or wireless network 118. At block 430, tracking the inventory item 132 includes receiving an updated status regarding a quantity and a location related to the inventory item 132. At block 440, tracking the inventory item 132 includes displaying the updated status on a screen 312 of the mobile device in real time.

FIG. 5 is a flow chart of another embodiment of a method for tracking in real time inventoried items by a consumer with a mobile device. At block 500, a server registers an inventory item 132 for a merchant 134 over a network. At block 510, the server receives regular status updates by the server comprising at least a quantity and location of the inventory item 132, wherein the regular status updates are indexed in a database of the server. At block 520, the server registers the mobile devices 105 of consumers via a cellular or wireless network 118 that desire to track the quantity and location of the inventory item. At block 530, the server sends regular status updates to mobile devices 105 of the consumers through the cellular or wireless network 118. At block 540, the updates are displayed on a screen 312 of the mobile devices 105, which enables the consumers to track at least the location and quantity of the inventory item 132.

In the foregoing description, numerous specific details of programming, software modules, user selections, network transactions, database queries, database structures, etc., are provided for a thorough understanding of various embodiments of the systems and methods disclosed herein. However, the disclosed system and methods can be practiced with other methods, components, materials, etc., or can be practiced without one or more of the specific details. In some cases, well-known structures, materials, or operations are not shown or described in detail. Furthermore, the described features, structures, or characteristics may be combined in any suitable manner in one or more embodiments. The components of the embodiments as generally described and illustrated in the Figures herein could be arranged and designed in a wide variety of different configurations.

The order of the steps or actions of the methods described in connection with the disclosed embodiments may be changed as would be apparent to those skilled in the art. Thus, any order appearing in the Figures, such as in flow charts, or in the Detailed Description is for illustrative purposes only and is not meant to imply a required order.

Several aspects of the embodiments described are illustrated as software modules or components. As used herein, a software module or component may include any type of computer instruction or computer executable code located within a memory device and/or transmitted as electronic signals over a system bus or wired or wireless network. A software module may, for instance, include one or more physical or logical blocks of computer instructions, which may be organized as a routine, program, object, component, data structure, etc. that performs one or more tasks or implements particular abstract data types.

In certain embodiments, a particular software module may include disparate instructions stored in different locations of a memory device, which together implement the described functionality of the module. Indeed, a module may include a single instruction or many instructions, and it may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices.

Various modifications, changes, and variations apparent to those of skill in the art may be made in the arrangement, operation, and details of the methods and systems disclosed. The embodiments may include various steps, which may be embodied in machine-executable instructions to be executed by a general-purpose or special-purpose computer (or other electronic device). Alternatively, the steps may be performed by hardware components that contain specific logic for performing the steps, or by any combination of hardware, software, and/or firmware. Embodiments may also be provided as a computer program product including a machine or computer-readable medium having stored thereon instructions that may be used to program a computer (or other electronic device) to perform processes described herein. The machine or computer-readable medium may include, but is not limited to, floppy diskettes, optical disks, CD-ROMs, DVD-ROMs, ROMs, RAMs, EPROMs, EEPROMs, magnetic or optical cards, propagation media or other type of media/machine-readable medium suitable for storing electronic instructions. For example, instructions for performing described processes may be transferred from a remote computer (e.g., a server) to a requesting computer (e.g., a client) by way of data signals embodied in a carrier wave or other propagation medium via a communication link (e.g., network connection).

1. A computer-implemented method for real-time inventory tracking with a mobile device, the method comprising:
receiving a communication for a stationary inventory item via a cellular or wireless network from a tracking server that is coupled with the cellular or wireless network; and
tracking the stationary inventory item on a registered consumer mobile device in real-time via the cellular or wireless network, wherein tracking comprises:
receiving an updated status regarding a quantity and a location related to the stationary inventory item; and
displaying the updated status on a screen of the mobile device in real time.

2. The method of claim 1, further comprising:
registering the consumer mobile device with the tracking server to track the stationary inventory item through a cellular or wireless network.

3. The method of claim 2, further comprising:
receiving from an indexed database of the tracking server a user-specific history including the stationary inventory item if the stationary inventory item had been previously tracked or searched for by the registered consumer mobile device.

4. The method of claim 1, wherein tracking the stationary inventory comprises receiving a future state or condition of the stationary inventory item, or receiving a current state or condition of the inventory item.

5. The method of claim 1, wherein the updated status of the stationary inventory item comprises one or more of: (1) time/date of arrival; (2) in storage; (3) on the shelves; (4) is available; (5) is out of stock; (6) location of current availability; and (7) a combination thereof.

6. The method of claim 1, wherein the stationary inventory item comprises one or more of a barcode, a radio frequency identification (RFID) tag, or a combination thereof, wherein the inventory item directly communicates wirelessly with the mobile device, the method further comprising:
using the mobile device is as a barcode scanner or as an RFID tag detector to verify an identity of the inventory item.

7. The method of claim 1, wherein the inventory item comprises a service slot selected from a group consisting of: a parking space, a barber shop chair, a restaurant table, and a movie theater seat.

8. The method of claim 1, further comprising:
searching for an updated status for the stationary inventory item in a database coupled with the tracking server.

9. The method of claim 1, further comprising:
updating a calendar or a task list on the mobile device based on receipt of the communication for the stationary inventory item.

10. A computer-implemented method of facilitating real-time mobile device tracking of inventory items, the method comprising:
registering an inventory item for a merchant with a server over a network;
receiving regular status updates by the server comprising at least a quantity and location of the inventory item, wherein the regular status updates are indexed in a database of the server; and
sending regular status updates, by the server, to previously-registered consumer mobile devices through a cellular or wireless network, wherein the status updates are displayed on a screen of the mobile devices, which enables the consumers to track at least the location and quantity of the inventory item.

11. The method of claim 10, further comprising:
registering, by the server, the consumer mobile devices via the cellular or wireless network that desire to track the quantity and location of the inventory item.

12. The method of claim 11, further comprising:
indexing, in an indexed database coupled with the server, user-specific history related to the inventory item as tracked by a registered mobile device; and
sending a status update to the registered mobile device containing inventory information related to an inventory item found in the indexed database.

13. The method of claim 10, wherein the server comprises a tracking front end, the method further comprising:
enabling the mobile device consumers to perform query searches of the tracking front end, wherein the tracking front end returns the current location, the quantity, a status, or a combination thereof of the inventory item from the database in response to the query.

14. The method of claim 10, wherein the inventory item comprises a service slot selected from a group consisting of: availability of a parking space, availability of seats at a theater, availability at a restaurant, and availability at a beauty salon.

15. The method of claim 10, wherein the status updates of the inventory item comprises one or more of: (1) time/date of arrival; (2) in storage; (3) on the shelves; (4) is available; (5) is out of stock; (6) location of current availability; and (7) a combination thereof.

16. The method of claim 10, wherein the consumer mobile devices comprise global position system (GPS) capability, wherein the inventory item comprises a location within a map of a building, a store, or a city, the method further comprising:
sending updates to the consumer mobile devices, which track their location within the building, the store, or the city on a map displayed thereon.

17. A system to enable real-time inventory tracking with mobile devices, the system comprising:
a server to enable merchants to register an inventory item over a network for the purpose of tracking the inventory item in real time, the server configured to receive regular updates comprising at least a quantity and a location of the inventory item from the merchants;
a database coupled with the server to index and store the updates of the inventory item; and
a processor coupled with the server, wherein the processor is configured to:
process the regular updates so that the at least quantity and location is current for the inventory item; and
send regular updates to mobile devices of consumers through a cellular or wireless network, wherein the updates are displayed on a screen of the mobile devices, which enables the consumers to track at least the location and quantity of the inventory item.

18. The system of claim 17, wherein the processor is configured to:
register mobile devices of consumers via a cellular or wireless network that desire to track at least the quantity and location of the inventory item.

19. The system of claim 18, wherein the database includes indexed user history of specific consumers that register their mobile devices to track the inventory item, wherein the processor is configured to:
send to a registered mobile device an update containing current or historical inventory information related to the inventory item for which is stored indexed user history for the registered mobile device.

20. The system of claim 17, further comprising:
a communicator to receive the regular updates from the inventory item, to receive registration requests of consumers of the mobile devices, and to send regular inventory updates to the mobile devices of the consumers in accordance with the registration requests.

21. The system of claim 17, wherein the updates are sent to the mobile devices of the consumers in response to a change in a state or of an attribute of the inventory item.

22. The system of claim 17, further comprising:
a tracking front end coupled with the server to enable the mobile device consumers to perform query searches of a search engine, wherein the tracking front end returns at least the location and quantity of the inventory item from the database in response to the query.

23. The system of claim 17, wherein the inventory item comprises a service slot selected from the group consisting of: availability of a parking space, availability of seats at a theater, availability at a restaurant, and availability at a beauty salon.

24. The system of claim 17, wherein the inventory item includes a barcode, a radio frequency identification (RFID) tag, or a combination thereof, the system further comprising:
a barcode scanner or an RFID reader to detect the inventory item in its direct proximity, which causes information in the database for the detected inventory item to be updated in real time.

25. The system of claim 17, wherein the consumer mobile devices comprise global position system (GPS) units for tracking a location of the mobile devices, wherein the inventory item comprises a location within a map of a building, a store, or a city, wherein the processor is configured to:
send updates to the consumer mobile devices, which track their location within the building, the store, or the city on a map displayed thereon.

26. The system of claim 17, wherein the real-time updates include a status, wherein the status of the inventory item comprises one or more of: (1) time/date of arrival; (2) in storage; (3) on the shelves; (4) is available; (5) is out of stock; (6) location of current availability; and (7) a combination thereof.

27. A consumer mobile device for real-time inventory tracking, comprising:
a transmitter configured to communicate over a cellular or wireless network with a tracking server containing updated information related to an inventory item, wherein the tracking server is coupled with the network;
a processor coupled with the transmitter configured to register the mobile device with the tracking server to continuously track the inventory item;
a receiver coupled with the processor configured to receive a communication for the inventory item via the cellular or wireless network from the tracking server, wherein the communication for the inventory item includes real-time updates of at least a location and a quantity of the inventory item; and
a display coupled with the processor configured to display the real-time updates of the inventory item as received from the tracking server, wherein the real-time updates include at least a location and quantity of the inventory item.

28. The mobile device of claim 27, wherein the quantity comprises availability of the inventory item, wherein the inventory item comprises a parking space, a salon chair, a restaurant table, a movie theater seat, or a club availability.

29. The mobile device of claim 28, further comprising:
an electronic calendar, wherein the calendar is updated based on at least the availability of the inventory item received in the real-time update.

30. The mobile device of claim 27, further comprising one or more of a bar code scanner, a radio frequency identification (RFID) reader, or a combination thereof to read a bar code, an RFID tag, or a combination thereof, respectively, detected in proximity of the mobile device to verify an identification of the inventory item at a physical location of a merchant thereof.

31. The mobile device of claim 27, wherein the real-time updates include a status, wherein the status of the inventory item comprises one or more of: (1) time/date of arrival; (2) in storage; (3) on the shelves; (4) is available; (5) is out of stock; (6) location of current availability; and (7) a combination thereof.

32. The mobile device of claim 31, wherein the tracking server comprises a database to store and index current updates of a plurality of inventory items, the mobile device further comprising:
a web browser configured to enable searching the indexed database for specific inventory items and corresponding statuses, locations, and quantities.

33. A machine-readable storage medium comprising programming code for real-time inventory tracking with a mobile device, the programming code operable to direct a processor to perform acts of:
receiving a communication for a stationary inventory item via a cellular or wireless network from a tracking server that is coupled with the cellular or wireless network; and
tracking the stationary inventory item on a registered consumer mobile device in real-time via the cellular or wireless network, wherein tracking comprises:
receiving an updated status regarding a quantity and a location related to the stationary inventory item; and
displaying the updated status on a screen of the mobile device in real time.

34. The machine-readable storage medium of claim 33, wherein the method further comprises:
registering the consumer mobile device with the tracking server to track the stationary inventory item through a cellular or wireless network.

35. The machine-readable storage medium of claim 34, wherein the method further comprises:
receiving from an indexed database of the tracking server a user-specific history including the stationary inventory item if the stationary inventory item had been previously tracked or searched for by the registered consumer mobile device.

36. The machine-readable storage medium of claim 33, wherein tracking the stationary inventory comprises receiving a future state or condition of the stationary inventory item, or receiving a current state or condition of the inventory item.

37. The machine-readable storage medium of claim 33, wherein the updated status of the stationary inventory item comprises one or more of: (1) time/date of arrival; (2) in storage; (3) on the shelves; (4) is available; (5) is out of stock; (6) location of current availability; and (7) a combination thereof.

38. The machine-readable storage medium of claim 33, wherein the stationary inventory item comprises one or more of a barcode, a radio frequency identification (RFID) tag, or a combination thereof, wherein the inventory item directly communicates wirelessly with the mobile device, the method further comprising:
using the mobile device is as a barcode scanner or as an RFID tag detector to verify an identity of the inventory item.

39. The machine-readable storage medium of claim 33, wherein the inventory item comprises a service slot selected from a group consisting of: a parking space, a barber shop chair, a restaurant table, and a theater seat.

40. The machine-readable storage medium of claim 33, searching for an updated status for the stationary inventory item in a database coupled with the tracking server.

41. The machine-readable storage medium of claim 33, updating a calendar or a task list on the mobile device based on receipt of the communication for the inventory item.

42. A machine-readable storage medium comprising programming code operable to be executed by a processor, the programming code comprising instructions operable to perform a method comprising:
registering an inventory item for a merchant with a server over a network;
receiving regular status updates by the server comprising at least a quantity and location of the inventory item, wherein the regular status updates are indexed in a database of the server; and
sending regular status updates, by the server, to previously-registered consumer mobile devices through a cellular or wireless network, wherein the status updates are displayed on a screen of the mobile devices, which enables the consumers to track at least the location and quantity of the inventory item.

43. The machine-readable storage medium of claim 42, wherein the method further comprises:
registering, by the server, the consumer mobile devices via the cellular or wireless network that desire to track the quantity and location of the inventory item.

44. The machine-readable storage medium of claim 43, wherein the method further comprises:
indexing, in an indexed database coupled with the server, user-specific history related to the inventory item as tracked by a registered mobile device; and
sending a status update to the registered mobile device containing inventory information related to an inventory item found in the indexed database.

45. The machine-readable storage medium of claim 42, wherein the server comprises a tracking front end, the method further comprising:
enabling the mobile device consumers to perform query searches of a search engine, wherein the tracking front end returns the current location, the quantity, a status, or a combination thereof of the inventory item from the database in response to the query.

46. The machine-readable storage medium of claim 42, wherein the inventory item comprises a service slot selected from a group consisting of: availability of parking spaces, a movie being played at a theater, availability at a restaurant, and availability at a beauty salon.

47. The machine-readable storage medium of claim 42, wherein the status updates of the inventory item comprises one or more of: (1) time/date of arrival; (2) in storage; (3) on the shelves; (4) is available; (5) is out of stock; (6) location of current availability; and (7) a combination thereof.

48. The machine-readable storage medium of claim 42, wherein the consumer mobile devices comprise global position system (GPS) capability, wherein the inventory item comprises a location within a map of a building, a store, or a city, the method further comprising:
sending updates to the consumer mobile devices, which track their location within the building, the store, or the city on a map displayed thereon.
